(19) United States
(12) Patent Application Publication
(10) Pub. No.: US 2025/0051046 A1
(43) Pub. Date: Feb. 13, 2025

(54) UNMANNED AERIAL VEHICLE AND A METHOD OF LANDING SAME

(71) Applicant: ARIEL SCIENTIFIC INNOVATIONS LTD., Ariel (IL)

(72) Inventor: Boaz BEN-MOSHE, Herzliya (IL)

(21) Appl. No.: 18/722,342

(22) PCT Filed: Dec. 22, 2022
(86) PCT No.: PCT/IL2022/051381

§ 371 Date: Jun. 20, 2024

(30) Foreign Application Priority Data
Dec. 23, 2021 (IL) 289357

(51) Int. Cl. B64U 70/95; B64U 10/14; B64U 20/87; B64U 70/40

(52) U.S. Cl. CPC B64U 70/95; B64U 20/87; B64U 70/40; B64U 10/14

(57) ABSTRACT

An unmanned aerial vehicle (UAV) is disclosed. The UAV comprises a body; a propulsion unit; a controller; and at least one adjustable camera unit. In some embodiments, each adjustable camera unit comprises, a camera; and a gimbal, mounting the camera, and configured to move the field of view (FOV) of the camera in at least two axes. In some embodiments, the controller is configured to: continuously receive a stream of images from the at least one camera; identify a tilted target in the stream of images; control the propulsion unit to approach the tilted target; and simultaneously control at least one gimble to rotate a corresponding camera such that the tilted target is continuously being identified in the stream of images.

### CROSS-REFERENCE TO RELATED APPLICATIONS

This application claims the benefit of priority of Israeli Patent Application No. 289357, titled “UNMANNED AERIAL VEHICLE AND A METHOD OF LANDING SAME”, filed Dec. 23, 2021, the contents of which are incorporated herein by reference in their entirety.

### FIELD OF THE INVENTION

The present invention relates generally to an unmanned aerial vehicle (UAV). More specifically, the present invention relates to a method for landing an unmanned aerial vehicle.

### BACKGROUND OF THE INVENTION

The use of UAVs, such as drones has increased significantly over the last decade, in light of technological advances. Vertical Take-Off and Landing (VTOL) drones are becoming popular in many sectors for multiple uses, for example, for mapping, surveying, remote sensing, inspection, search and rescue applications, and filming recreational, and sports.

Most commercial drones are equipped with a Global Navigation Satellite System (GNSS) receiver, which is used for performing Return-To-Home (RTH) procedure, each time the UAV is expected to land. In most cases, this operation is performed by flying at a fixed height to a point above the launch location and then performing a vertical landing.

When coming to land on dynamic platforms, such as a traveling car, a sailing ship, and the like, the vertical landing is very challenging since the landing point is constantly moving.

Accordingly, there is a need for a method for an autonomous precise landing of UAVs on dynamic platforms.

### SUMMARY OF THE INVENTION

Some aspects of the invention are directed to an unmanned aerial vehicle (UAV), comprising: a body; a propulsion unit; a controller; and at least one adjustable camera unit. In some embodiments, each adjustable camera unit comprises, a camera; and a gimbal, mounting the camera, and configured to move the field of view (FOV) of the camera in at least two axes. In some embodiments, the controller is configured to: continuously receive a stream of images from the at least one camera; identify a tilted target in the stream of images; control the propulsion unit to approach the tilted target; and simultaneously control at least one gimble to rotate a corresponding camera such that the tilted target is continuously being identified in the stream of images.

In some embodiments, identifying the tilted target during the approach of the UVA is such that the tilted target is located at the center of the FOV of at least one camera. In some embodiments, controlling the propulsion unit is based on images comprising the tilted target located at the center of the FOV of at least one camera. In some embodiments, controlling the propulsion unit comprises: receiving coordinates and a tilting angle of the tilted target, receiving a temporal tilting angle of each gimbal when the tilted target is located at the center of the FOV of each camera; calculating a temporal position of the unmanned aerial vehicle based on, the angle and the coordinates of the tilted target and the temporal tilting angle of each gimbal; and determining temporal population parameters based on the temporal position. In some embodiments, the tilting angle is measured with respect to the horizon.

In some embodiments, the controller is further configured to: identify a substantially horizontal target in the stream of images; control at least one gimble to rotate a corresponding camera such that both the tilted target and the substantially horizontal target are continuously being identified in the stream of images; and control the propulsion unit to approach the substantially horizontal target while approaching the tilted target, until the substantially horizontal target is located substantially vertically below the UVA.

In some embodiments, the propulsion unit controls an approach the substantially horizontal target until the substantially horizontal target is located at the center of an image taken when the at least one gimbal is tilted at −90° with respect to the horizon. In some embodiments, controlling the propulsion unit comprises: further receiving coordinates of the substantially horizontal target; and calculating the temporal position of the unmanned aerial vehicle is also based on the coordinates of the substantially horizontal target. In some embodiments, the controller is further configured to control the propulsion unit to approach the target until only the tilted target is identified in the stream of images. In some embodiments, the controller is further configured to control the propulsion unit to vertically approach the target.

In some embodiments, the tilted target comprises a first ArUco marker and the substantially horizontal target comprises a second ArUco marker different from the first ArUco marker. In some embodiments, a tilting angle of the target is between 20 to 80 degrees. In some embodiments, the tilted target is located at a distance of between 0.5 m to 10 m from the substantially horizontal target.

In some embodiments, at least one gimbal is configured to rotate at an angle of −90° to +20°.

Some aspects of the invention are directed to a method of landing an unmanned aerial vehicle (UAV), comprising: continuously receiving a stream of images from at least one camera mounted on a gimbal assembled on the bottom of the UVA, when the UVA is hovering; identifying a tilted target in the stream of images; controlling a propulsion unit of the UVA to approach the tilted target, and simultaneously controlling the gimble to rotate the camera such that the tilted target is continuously being identified in the stream of images.

In some embodiments, identifying the tilted target during the approach of the UVA is such that the tilted target is located at the center of the FOV of the at least one camera. In some embodiments, controlling the propulsion unit is based on images comprising the tilted target located at the center of the FOV of the at least one camera.

In some embodiments, controlling the propulsion unit comprises: receiving coordinates and a tilting angle of the tilted target, receiving a temporal tilting angle of the gimbal when the tilted target is located at the center of the FOV of the at least one camera; calculating a temporal position of the unmanned aerial vehicle based on, the angle and the coordinates of the tilted target and the temporal tilting angle of the gimbal; and determining temporal population parameters based on the temporal position.

In some embodiments, the tilting angle is measured with respect to the horizon. In some embodiments, the temporal propulsion parameters comprise at least two of vertical velocity, vertical acceleration, horizontal velocity, and horizontal acceleration.

In some embodiments, the method further comprises; identifying a substantially horizontal target in the stream of images; controlling the gimble to rotate a corresponding camera such that both the tilted target and the substantially horizontal target are continuously being identified in the stream of images; and controlling the propulsion unit to approach the substantially horizontal target while approaching the tilted target, until the substantially horizontal target is located substantially vertically below the UVA. In some embodiments, controlling the propulsion unit to approach the substantially horizontal target is until the substantially horizontal target is located at the center of an image taken when the gimbal is tilted at −90° with respect to the horizon. In some embodiments, controlling the propulsion unit comprises: further receiving coordinates of the substantially horizontal target, and calculating the temporal position of the unmanned aerial vehicle also based on the coordinates of the substantially horizontal target.

In some embodiments, controlling the propulsion unit is to vertically approach the target until only the tilted target is identified in the stream of images. In some embodiments, the tilted target comprises a first ArUco marker and the substantially horizontal target comprises a second ArUco marker different than the first. In some embodiments, the tilting angle is between 20 to 80 degrees.

Some additional aspects of the invention a target system for landing an unmanned aerial vehicle (UAV), comprising: a substantially horizontal target; and a tilted target, located at a known distance from the substantially horizontal target and tilted at a known angle with respect to a surface plane of the substantially horizontal target.

In some embodiments, the substantially horizontal target comprises a first ArUco marker and the tilted target comprises a second ArUco marker different from the first ArUco marker. In some embodiments, the tilting angle is between 20 to 80 degrees. In some embodiments, the known distance is between 0.5 m to 10 m.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an illustration of a UAV according to some embodiments of the invention;

FIG. 1B is a block diagram, depicting a computing device that may be included in a system for landing a UAV of a dynamic platform according to some embodiments of the invention;

FIGS. 2A and 2B are illustrations of vision-based landing parameters according to some embodiments of the invention;

FIG. 2C is an illustration of a target according to some embodiments of the invention;

FIGS. 3A, 3B, and 3C are illustrations of a vision-based vertical landing process according to some embodiments of the invention;

FIGS. 4A, 4B, 4C, and 4D are illustrations of a vision-based distance landing process according to some embodiments of the invention;

FIG. 5 is a flowchart of a method of landing a UAV according to some embodiments of the invention; and

FIGS. 6A, 6B, 6C, 6D, 6E and 6F are illustrations of a vision-based landing process according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing devices, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention disclose a system and a method for landing UAV on a dynamic platform. The system may perform a vision-based landing process assisted by two targets, a substantially horizontal target, and a tilted target. Each target may include a different detectable marker, for example, a different ArUco marker.

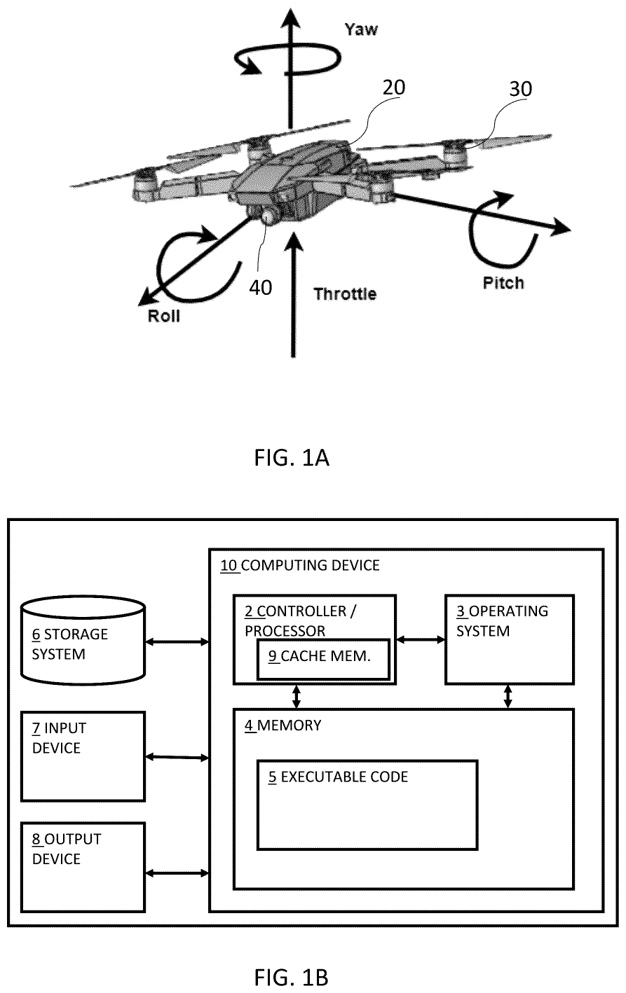

Reference is now made to FIG. 1A which is an illustration of a UAV 100 according to some embodiments of the invention. In some embodiments, UAV 100 may include a body 20, a propulsion unit 30, and a computing device 10 comprising a controller 2, illustrated and discussed with respect to FIG. 1B. In some embodiments, UAV 100 may be a VTOL drone, as illustrated and body 20 and propulsion unit 30 may include any suitable component of the VTOL drones known in the art. For example, propulsion unit 30 may include a quadrotor (e.g., 4 propulsion rotors) as illustrated. The quadrotor allows simple control of the yaw, roll, pitch, and throttle movements of UAV 100. As used herein the yaw movement is the ability of the UAV to rotate, the roll movement is the ability of the UAV to move from left to right and back, the pitch movement is the ability of the UAV to move backward, and forward and the throttle movement is the ability of the UAV to change its altitude.

UAV 100 may further include at least one adjustable camera unit 40. In some embodiments, each camera unit 40 may include a camera and a gimbal, mounting the camera, and configured to move the field of view (FOV) of the camera in at least two axes (e.g., in three axes or four axes). The camera may be any optical camera configured to capture a stream of images. The gimble may have the ability to move in at least one axis, for example, the gimble may provide a pitch movement and/or a yaw movement to the camera at a tilting angle of between −90° to +20° degrees.

In some embodiments, UAV 100 may further include a positioning sensor, such as a GPS, an optical flow sensor, or any other additional sensor.

Reference is now made to FIG. 1B, which is a block diagram depicting a computing device, which may be included within an embodiment of a controller of a UAV 100, according to some embodiments. Computing device 10 may be included/assembled in body 20 or may remotely control propulsion unit 30 by communicating with a communication unit included in UVA 100.

Computing device 10 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc.

Operating system 3 may be or may include any code segment (e.g., one similar to executable code 5 described herein) designed and/or configured to perform tasks involving coordination, scheduling, arbitration, supervising, controlling or otherwise managing operation of computing device 10, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task or script. Executable code 5 may be executed by processor or controller 2 possibly under the control of operating system 3. For example, executable code 5 may be an application that may control a UAV landing as further described herein. Although, for the sake of clarity, a single item of executable code 5 is shown in FIG. 1B, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a microcontroller or chip as known in the art, a hard disk drive, a CD-Recordable (CD-R) drive, a Blu-ray disk (BD), a universal serial bus (USB) device or other suitable removable and/or fixed storage unit. Target-related data, the UAV data and parameters, and the like may be stored in storage system 6 and may be loaded from storage system 6 into memory 4 where it may be processed by processor or controller 2. In some embodiments, some of the components shown in FIG. 1B may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse, and the like. Output devices 8 may include one or more (possibly detachable) displays or monitors, speakers, and/or any other suitable output devices. Any applicable input/output (I/O) devices may be connected to Computing device 1 as shown by blocks 7 and 8. For example, a wired or wireless network interface card (NIC), a universal serial bus (USB) device or an external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

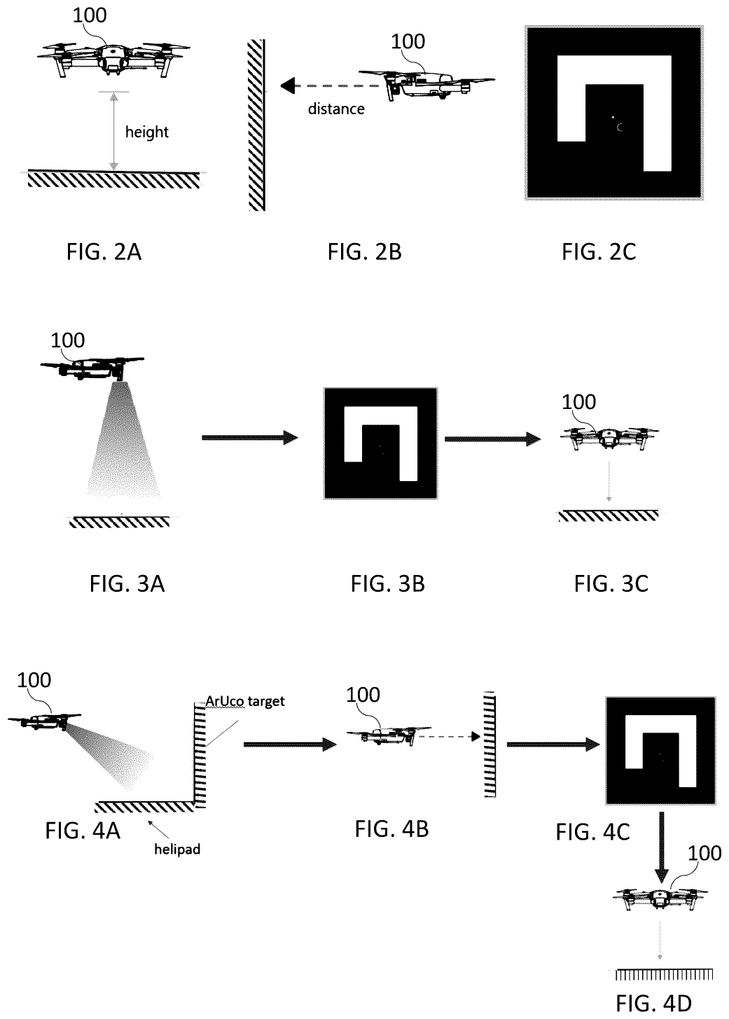

In some embodiments, controller 2 of computing device 10 may be configured to control propulsion unit 30 to land UAV 100 using a vision-based landing procedure. A vision-based landing procedure is an autonomous lending process based on visual detection of a target, for example, a target comprising an ArUco marker. ArUco markers are binary square fiducial markers that can be used for camera pose estimation. Illustrations of ArUco markers on targets are given in FIGS. 2C, 3B, 6B and 6D. Placing the ArUco marker on a target placed in proximity to the landing point may assist in calculating vision-based landing parameters, such as the distance and the height required in any vision-based landing process.

Reference is now made to FIGS. 2A and 2B are illustrations of vision-based landing parameters according to some embodiments. In some embodiments, the distance between camera unit 40 and the target can be calculated using the following equations:

$$F = ( D \div W ) \times P \qquad ( 1 )$$

Wherein, F is the focal length of the camera, W is a known width of the ArUco marker, P is the apparent width in pixels of the ArUco marker, and D is the distance from the camera to the target.

In some embodiments, following a calibration process and finding the focal length F (e.g., by taking images of the ArUco marker at known distances D), the same equation can be used to find the distance between the camera and the target.

$$D = ( F \times W ) \div P \qquad ( 2 )$$

The rotation matrix of the UAV can be described by equation (3).

$$Rd = [ \begin{matrix}cos ( α ) cos ( β ) & cos ( α ) sin ( β ) sin ( γ ) - sin ( α ) cos ( γ ) & cos ( α ) sin ( β ) cos ( γ ) + sin ( α ) sin ( γ ) \\ sin ( α ) cos ( β ) & sin ( α ) sin ( β ) sin ( γ ) + cos ( α ) cos ( γ ) & sin ( α ) sin ( β ) cos ( γ ) - cos ( α ) sin ( γ ) \\ - sin ( β ) & cos ( β ) sin ( γ ) & cos ( β ) cos ( γ )\end{matrix} ] \qquad ( 3 )$$

Wherein α is the yaw angle and β is the pitch angle γ and is the roll angle.

A pitch rotation of the camera gimbal is described by equation (4).

$$Rg = [ \begin{matrix}cos ( θ ) & 0 & sin ( θ ) \\ 0 & 1 & 0 \\ - sin ( θ ) & 0 & cos ( θ )\end{matrix} ] \qquad ( 4 )$$

Wherein θ is the gimbal tilting angle.

Accordingly, the rotation matrix of the system can be given by equation (5).

$$R = [ \begin{matrix}c ( α ) c ( β ) c ( θ ) - s ( θ ) [ c ( α ) s ( β ) c ( γ ) + s ( α ) s ( γ ) ] & c ( α ) s ( β ) s ( γ ) - s ( α ) c ( γ ) & c ( α ) c ( β ) s ( θ ) + c ( θ ) [ c ( α ) s ( β ) c ( γ ) + s ( α ) s ( γ ) ] \\ s ( α ) c ( β ) c ( θ ) - s ( θ ) [ s ( α ) s ( β ) c ( γ ) - c ( α ) s ( γ ) ] & s ( α ) s ( β ) s ( γ ) + c ( α ) c ( γ ) & s ( α ) c ( β ) s ( θ ) + c ( θ ) [ s ( α ) s ( β ) c ( γ ) - c ( α ) s ( γ ) ] \\ - s ( β ) c ( θ ) - s ( θ ) c ( β ) c ( γ ) & c ( β ) s ( γ ) & - s ( β ) s ( θ ) + c ( θ ) c ( β ) c ( γ )\end{matrix} ] \qquad ( 5 )$$

In some embodiments, equations (4) and (5) may be used by computing device 10 to control the movement of camera unit 40 and propulsion unit 30.

### Vision-Based Landing Procedures

In some embodiments, a substantially horizontal target comprising the ArUco marker is placed on the landing platform at the required landing area to assist in vision-based vertical landing procedure, as illustrated in FIGS. 3A, 3B, and 3C. In vision-based vertical landing procedure, the gimbal may be fixed at −90° and UAV 100 may hover above the landing area (FIG. 3A) until an image of the ArUco marker is captured by the camera (FIG. 3B). When controller 2 recognizes the ArUco marker in an image captured by camera unit 40, propulsion unit 30 is controlled to reduce the altitude of UAV 100 (FIG. 3C) while continuing to capture the image of the ArUco marker until a complete landing is achieved. The disadvantage of this method is that at a certain low altitude, camera unit 40 can no longer capture the image of the ArUco marker, which can change in position with respect to UAV 100 if the target is placed on a dynamic platform that can suddenly change its height or location, such as a boat on the sea.

In some embodiments, an additional vision-based landing process, known as the vision-based distance landing process can be used for autonomous landing. In the vision-based distance landing process, an additional vertical target comprising the ArUco marker is placed on a vertical wall at a known distance from to landing area. This process of vision-based distance landing process is illustrated in FIGS. 4A, 4B, 4C, and 4D. In some embodiments, the gimbal of camera unit 40 may be fixed at −45, ° and UAV 100 may fly towards the landing area until two images of both the horizontal and the vertical ArUco markers are captured by the camera (FIG. 4A). In the next step, controller 2 may control propulsion unit 30 to reduce the distance between UAV 100 and the vertical ArUco marker target (FIG. 4B) until the horizontal ArUco marker (FIG. 4C) is located substantially beneath hovering UAV 100. Then in some embodiments, controller 2 controls propulsion unit 30 to reduce the altitude of UAV 100 (FIG. 4D) while continuing to capture the image ofthe ArUco marker until a complete landing is achieved. The vision-based distance landing process has the same disadvantages of the vision-based vertical landing process.

Accordingly, there is a need for a more reliable autonomous vision-based landing process for landing UAVs on dynamic platforms, such as, boats at sea, traveling land vehicles, and the like.

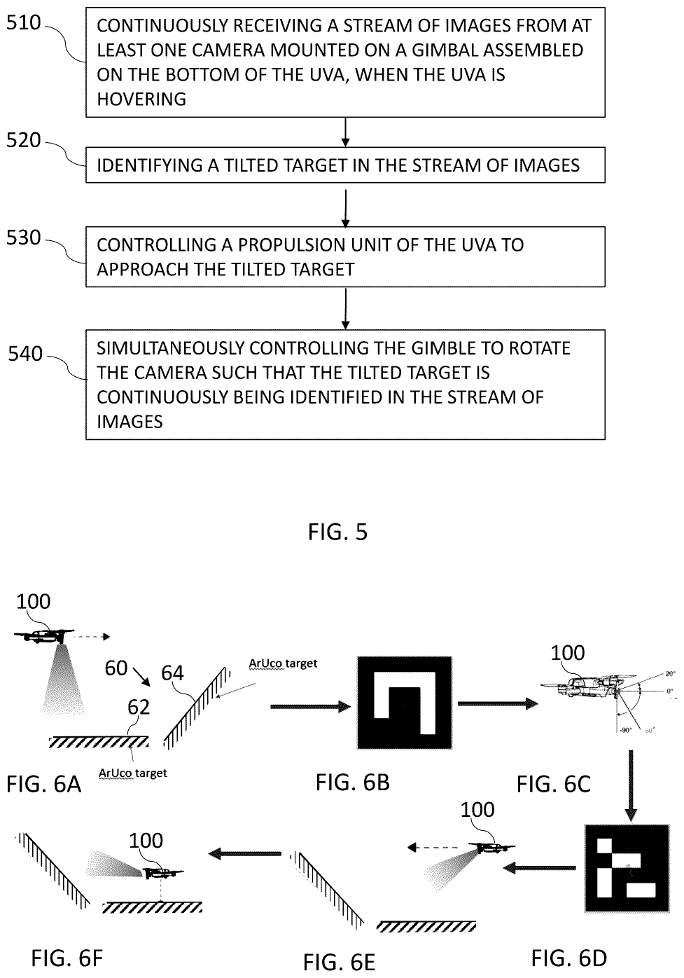

In such a method the additional ArUco marker is placed on a titled target as illustrated in FIG. 6A and discussed with respect to the flowchart of FIG. 5.

Reference is now made to FIG. 5 which is a flowchart of a method of landing an unmanned aerial vehicle (e.g., UAV 100) according to some embodiments of the invention. The method of FIG. 5 may be performed by a controller, such as controller 2 included in computing device 10, or by any other suitable controller.

In step 510, a stream of images may be continuously received from at least one camera mounted on a gimbal assembled on the bottom of the UVA, when the UVA is hovering. For example, controller 2 may receive from the camera of camera unit 40 a stream of images as UAV 100 is approaching a landing location. UAV 100 may be controlled to approach the lading location based on signals received from a positioning sensor such as a GPS sensor. In some embodiments, two targets may be placed at the landing location, a substantially horizontal target 62 comprising a first ArUco marker, such as the ArUco marker illustrated in FIG. 6B and a tilted target 64 comprising a second ArUco marker, such the ArUco marker illustrated in FIG. 6D.

In step 520, a tilted target may be identified in the stream of images. For example, controller 2 may identify the second ArUco marker illustrated in FIG. 2D on tilted target 64. In some embodiments, the controller may first identify the first ArUco marker illustrated in FIG. 6B, as discussed above with respect to the vision-based vertical landing process. In some embodiments, identifying tilted target 64 during the approach of the UVA is such that the tilted target is located at the center of the FOV of at least one camera.

In step 530, propulsion unit 20 of UVA 100 is controlled to approach the tilted target

In step 540, at least one gimble, of at least one camera unit 40, is simultaneously controlled to rotate the camera such that tilted target 64 is continuously being identified in the stream of images, as illustrated in FIGS. 6C, 6D and 6C. In some embodiments, at a certain predetermined distance from the tilted target, propulsion unit 20 of UVA 100 may then be controlled to reduce the latitude of UAV 100. The reduction in latitude may be conducted while simultaneously controlling the gimbal to tilt the camera such that the ArUco marker on tilted target 64 is being continuously identified in the stream of images.

In some embodiments, controlling propulsion unit 30 is based on images comprising the tilted target which are located at the center of the FOV of at least one camera. In some embodiments, controlling the propulsion unit 30 may include, receiving coordinates and a tilting angle of tilted target 64. In some embodiments, the tilting angle may be is between 20 to 80 degrees, measured with respect to the horizon. In some embodiments, controlling propulsion unit 30 may further include, receiving a temporal tilting angle of at least one gimbal when the tilted target is located at the center of the FOV of at least one camera, calculating a temporal position of the unmanned aerial vehicle based on, the angle and the coordinates of the tilted target and the temporal tilting angle of the at least one gimbal and determining temporal population parameters based on the temporal position. In some embodiments, the temporal population parameters include, at least two of vertical velocity, vertical acceleration, horizontal velocity, and horizontal acceleration, calculated, for example, using any one of equations (1)-(6).

In some embodiments, controller 2 may further be configured to identify substantially horizontal target 62 (e.g., the target in FIG. 6B) in the stream of images; control at least one gimble to rotate a corresponding camera such that both the tilted target and the substantially horizontal target are continuously being identified in the stream of images; and control propulsion unit 30 to approach the substantially horizontal target while approaching tilted target 64, until substantially horizontal target 62 is located substantially vertically blow UVA 100, as illustrated in FIG. 6F. In some embodiments, controller 2 may control propulsion unit 30 to approach substantially horizontal target 62 is until the substantially horizontal target is located at the center of an image taken when the gimbal is tilted at −90°. As discussed above with respect to FIGS. 2A-2C.

In some embodiments, controlling propulsion unit 30 may include further receiving coordinates of substantially horizontal target 62; and calculating the temporal position of UAV 100 also based on the coordinates of the substantially horizontal target. In some embodiments, controller 2 may further be configured to control propulsion unit 30 to vertically approach target 64 until only tilted target 64 is identified in the stream of images.

Some additional aspects of the invention may be directed to a target system for landing an unmanned aerial vehicle (UAV), for example, a target system 60 illustrated in FIG. 6A. Target system 60 may include substantially horizontal target 62, and tilted target 64, located at a known distance from first target 62 and tilted at a known angle with respect to a surface plane of target 62. In some embodiments, target 62 may include a first ArUco marker (illustrated in FIG. 6B) and second target 63 may include a second ArUco marker (illustrated in FIG. 6D) different than the first.

In some embodiments, the tilting angle is between 20 to 80 degrees. In some embodiments, the known distance is between 0.5 m to 10 m.

The above method and target system may allow an autonomous vision-based landing process for landing UAVs on dynamic platforms, due to the ability of camera unit 40 to receive images from a system of targets at a variety of angles. Therefore, movement of the landing area either in the horizontal or vertical direction may be followed by a change in the tilting angle of the camera in camera unit 40 allowing controller 2 to follow at least tilted target 64 at target system 60 until the safe landing.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. An unmanned aerial vehicle (UAV), comprising:
a body;
a propulsion unit;
a controller; and
at least one adjustable camera unit, each comprising:
a camera; and
a gimbal, mounting the camera, and configured to move the field of view (FOV) of the camera in at least two axes,
wherein the controller is configured to:
continuously receive a stream of images from the at least one camera;
identify a tilted target in the stream of images;
control the propulsion unit to approach the tilted target; and
simultaneously control at least one gimble to rotate a corresponding camera such that the tilted target is continuously being identified in the stream of images.

2. The unmanned aerial vehicle of claim 1, wherein identifying the tilted target during the approach of the UVA is such that the tilted target is located at the center of the FOV of at least one camera.

3. The unmanned aerial vehicle of claim 2, wherein controlling the propulsion unit is based on images comprising the tilted target located at the center of the FOV of at least one camera.

4. The unmanned aerial vehicle of claim 2, wherein controlling the propulsion unit comprises:
receiving coordinates and a tilting angle of the tilted target,
receiving a temporal tilting angle of each gimbal when the tilted target is located at the center of the FOV of each camera;
calculating a temporal position of the unmanned aerial vehicle based on, the angle and the coordinates of the tilted target and the temporal tilting angle of each gimbal; and
determining temporal population parameters based on the temporal position.

5. The unmanned aerial vehicle of claim 4, wherein the tilting angle is measured with respect to the horizon.

6. The unmanned aerial vehicle according to claim 1, wherein the controller is further configured to:
identify a substantially horizontal target in the stream of images;
control at least one gimble to rotate a corresponding camera such that both the tilted target and the substantially horizontal target are continuously being identified in the stream of images; and
control the propulsion unit to approach the substantially horizontal target while approaching the tilted target, until the substantially horizontal target is located substantially vertically blow the UVA.

7. The unmanned aerial vehicle of claim 6, wherein the propulsion unit controls an approach the substantially horizontal target until the substantially horizontal target is located at the center of an image taken when the at least one gimbal is tilted at −90° with respect to the horizon.

8. The unmanned aerial vehicle of claim 6, wherein controlling the propulsion unit comprises:
further receiving coordinates of the substantially horizontal target; and
calculating the temporal position of the unmanned aerial vehicle is also based on the coordinates of the substantially horizontal target.

9. The unmanned aerial vehicle of claim 7, wherein the controller is further configured to control the propulsion unit to approach the target until only the tilted target is identified in the stream of images.

10. The unmanned aerial vehicle of claim 9, wherein the controller is further configured to control the propulsion unit to vertically approach the target.

11. The unmanned aerial vehicle according to claim 6, wherein the tilted target comprises a first ArUco marker and the substantially horizontal target comprises a second ArUco marker different from the first ArUco marker.

12. The unmanned aerial vehicle according to claim 2, wherein a tilting angle of the target is between 20 to 80 degrees.

13. The unmanned aerial vehicle according to claim 6, wherein the tilted target is located at a distance of between 0.5 m to 10 m from the substantially horizontal target.

14. The unmanned aerial vehicle according to claim 1, wherein at least one gimbal is configured to rotate at an angle of −90° to +20°.

15. A method of landing an unmanned aerial vehicle (UAV), comprising:
continuously receiving a stream of images from at least one camera mounted on a gimbal assembled on the bottom of the UVA, when the UVA is hovering;
identifying a tilted target in the stream of images;
controlling a propulsion unit of the UVA to approach the tilted target; and
simultaneously controlling the gimble to rotate the camera such that the tilted target is continuously being identified in the stream of images.

16. The method of claim 15, wherein identifying the tilted target during the approach of the UVA is such that the tilted target is located at the center of the FOV of the at least one camera.

17. The method of claim 16, wherein controlling the propulsion unit is based on images comprising the tilted target located at the center of the FOV of the at least one camera.

18. The method of claim 16, wherein controlling the propulsion unit comprises:
receiving coordinates and a tilting angle of the tilted target,
receiving a temporal tilting angle of the gimbal when the tilted target is located at the center of the FOV of the at least one camera;
calculating a temporal position of the unmanned aerial vehicle based on, the angle and the coordinates of the tilted target and the temporal tilting angle of the gimbal; and
determining temporal population parameters based on the temporal position.

19. The method of claim 18, wherein the tilting angle is measured with respect to the horizon.

20.-25. (canceled)

26. A target system for landing an unmanned aerial vehicle (UAV), comprising: a substantially horizontal target; and
a tilted target, located at a known distance from the substantially horizontal target and tilted at a known angle with respect to a surface plane of the substantially horizontal target.

27.-30. (canceled)
